(19) United States
(12) Patent Application Publication
(10) Pub. No.: US 2026/0094952 A1
(43) Pub. Date: Apr. 2, 2026

(54) ENERGY STORAGE CELL

(71) Applicant: TOYOTA JIDOSHA KABUSHIKI KAISHA, Toyota-shi Aichi-ken (JP)

(72) Inventors: Shinya ISHIKAWA, Anjo-shi Aichi-ken (JP); Yusuke KINTSU, Miyoshi-shi Aichi-ken (JP); Takumi TANAKA, Toyota-shi Aichi-ken (JP); Masayoshi HAGA, Nagoya-shi Aichi-ken (JP); Kazuki MURAISHI, Toyota-shi Aichi-ken (JP); Yuji YAMASHITA, Toyota-shi Aichi-ken (JP); Aya SATO, Nagoya-shi Aichi-ken (JP)

(73) Assignee: TOYOTA JIDOSHA KABUSHIKI KAISHA, Toyota-shi Aichi-ken (JP)

(21) Appl. No.: 19/181,695

(22) Filed: Apr. 17, 2025

(30) Foreign Application Priority Data
Jul. 16, 2024 (JP) 2024-113202

(51) Int. Cl. H01M 50/562; H01M 50/103; H01M 50/548; H01M 50/557

(52) U.S. Cl. CPC H01M 50/562; H01M 50/103; H01M 50/548; H01M 50/557; H01M 2220/20

(57) ABSTRACT

An energy storage cell includes a case, an electrode terminal, and a power generation element. The case houses the power generation element. The electrode terminal includes a cathode terminal and an anode terminal. The electrode terminal includes a member contact portion that is in contact with a different member. Either or both of the cathode terminal and the anode terminal have a recess in the member contact portion.

### CROSS-REFERENCE TO RELATED APPLICATION

This application claims priority to Japanese Patent Application No. 2024-113202 filed on Jul. 16, 2024, incorporated herein by reference in its entirety.

### BACKGROUND

### 1. Technical Field

The present disclosure relates to energy storage cells.

### 2. Description of Related Art

Japanese Unexamined Patent Application Publication No. 2017-16734 (JP 2017-16734 A) discloses an energy storage device including a current interruption mechanism as a safety mechanism in order for an abnormality in the energy storage device not to be transmitted to another energy storage device when the abnormality occurs in the energy storage device.

### SUMMARY

However, the current interruption mechanism described in JP 2017-16734 A has a complicated structure, and there is a demand for a simpler safety mechanism.

An object of the present disclosure is to provide a simple safety mechanism.

A technical configuration, operations, and effects of the present disclosure will be described below. Note that the operation mechanism includes estimation. The operation mechanism does not limit the technical scope of the present disclosure.
(1) An energy storage cell including a case, an electrode terminal, and a power generation element.
The case houses the power generation element.
The electrode terminal includes a cathode terminal and an anode terminal.
The electrode terminal includes a member contact portion that is in contact with a different member.
Either or both of the cathode terminal and the anode terminal include a recess in the member contact portion.

Either or both of the cathode terminal and the anode terminal include the recess in the member contact portion with the different member. Since the electrode terminal includes the recess in the member contact portion, the contact area between the electrode terminal and the different member is reduced. Therefore, when an external force such as an impact is applied to the electrode terminal, the electrode terminal and the different member are more easily disengaged from each other. As a result, the electrode terminal and the different member are separated from each other, and the electrically conductive path can be interrupted.
(2) In the energy storage cell according to (1),
the cathode terminal and the anode terminal may have the recess in the member contact portion.
(3) In the energy storage cell according to (1) or (2),
the different member may be a busbar.
(4) In the energy storage cell according to any one of (1) to (3), the electrode terminal may be made of an electrically conductive ceramic material.
(5) In the energy storage cell according to any one of (1) to (4),
the electrode terminal may be configured to face outside a vehicle when the energy storage cell is mounted on the vehicle.

An embodiment of the present disclosure (hereinafter sometimes simply referred to as “present embodiment”) will be described below. However, the present embodiment is not intended to limit the technical scope of the present disclosure. The present embodiment is illustrative in all respects. The present embodiment is not restrictive. The technical scope of the present disclosure includes all modifications that fall within the meaning and scope equivalent to the claims. For example, it is originally planned to extract any desired configurations from the present embodiment and combine them as desired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of an energy storage cell according to the present embodiment;

FIG. 2 is a schematic cross-sectional view illustrating an example of an energy storage cell according to the present embodiment;

FIG. 3 is a schematic plan view illustrating an example of the vicinity of an electrode terminal in the present embodiment;

FIG. 4 is a schematic plan view illustrating another example of the vicinity of the electrode terminal in the present embodiment;

FIG. 5 is a schematic plan view illustrating an exemplary energy storage cell according to the present embodiment when the energy storage cell is mounted on a vehicle; and

FIG. 6 is a schematic plan view showing another example in the case where the energy storage cell according to the present embodiment is mounted on a vehicle.

### DETAILED DESCRIPTION OF EMBODIMENTS

### Terms and Phrases

The terms “comprising,” “including,” and “having” and their variations are open-ended terms. An open-ended term may or may not further include additional elements in addition to the stated elements. The expression “consisting of” is a closed term. However, even a configuration described with a closed term may include impurities ordinarily associated therewith and additional elements irrelevant to the disclosed technique. The expression “substantially consisting of” is a semi-closed term. A semi-closed term allows addition of elements that do not materially affect the basic and novel properties of the subject technology.

Expressions such as “may” and “can” are used in the permissive sense of “having the possibility of” rather than in the obligatory sense of “must”.

Geometric terms should not be construed in a strict sense. Examples of the geometric terms include “parallel”, “vertical”, and “orthogonal”. For example, directions, angles, distances, and the like may be relatively displaced within a range that provides substantially the same or similar functionality. The geometric terms may include, for example, design-related, work-related, or manufacturing-related, tolerances, variations, and so forth. Dimensional relationships in each drawing may not match actual dimensional relationships. The dimensional relationships in the drawings may be changed to facilitate understanding by readers. For example, the length, width, thickness, and so forth, may be changed. Some configurations may be omitted.

Elements described in the singular form may also include the plural form unless specified otherwise. For example, the electrode terminal may indicate a plurality of electrode terminals (electrode terminal groups).

The “energy storage cell” refers to a rechargeable cell. The energy storage cell may be, for example, a lithium-ion cell. The energy storage cell may include, for example, a liquid electrolyte, a gel electrolyte, or a solid electrolyte.

The “electrode” is a generic term for a cathode and an anode. Similarly, for example, the “electrode terminal” is a generic term for a cathode terminal and an anode terminal. The “current collector tab” is a generic term for a cathode current collector tab and an anode current collector tab.

The “energy storage module” includes a plurality of energy storage cells. The energy storage module is a collection of the plurality of energy storage cells connected together. The “energy storage device” includes a plurality of energy storage modules. The energy storage device is a collection of the plurality of energy storage modules connected together.

### Energy Storage Cell

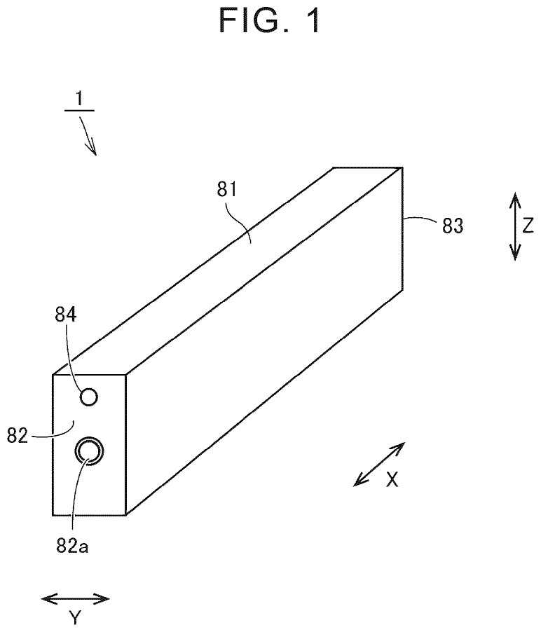

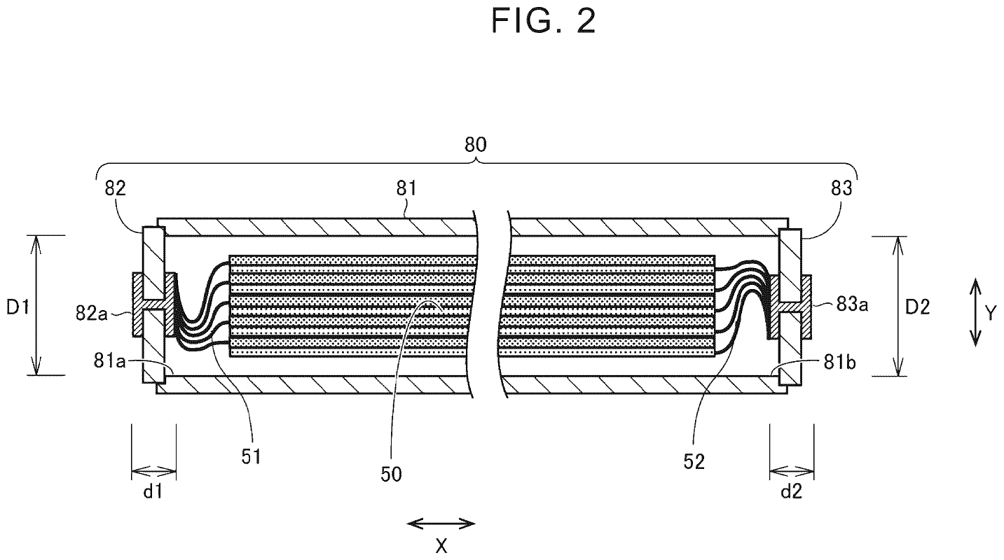

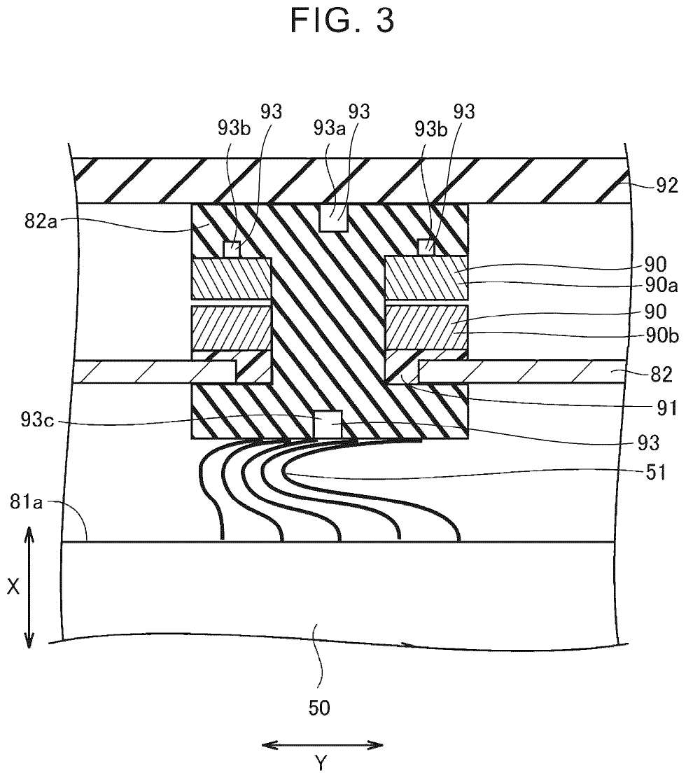

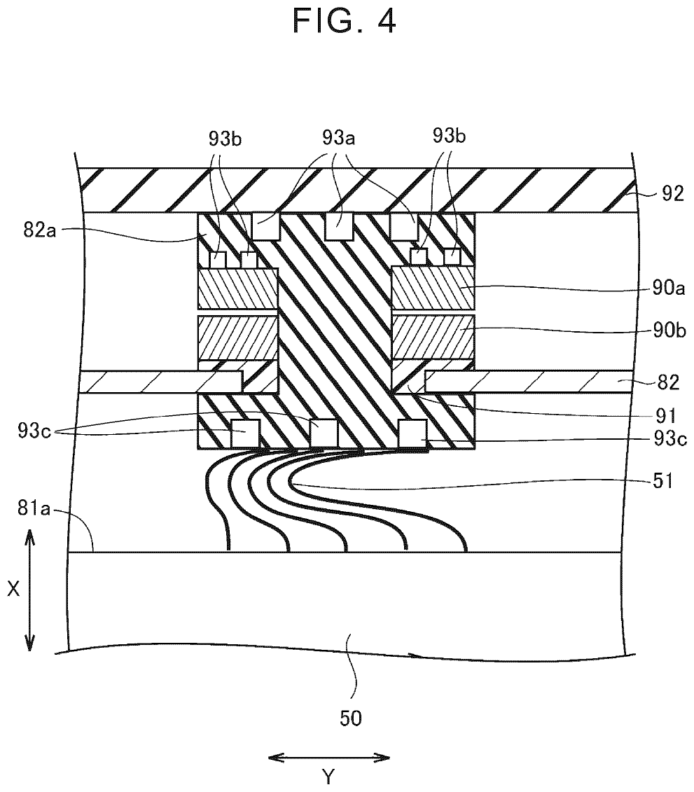

FIG. 1 is a schematic diagram illustrating an example of an energy storage cell according to the present embodiment. FIG. 2 is a schematic cross-sectional view illustrating an example of an energy storage cell according to the present embodiment. FIG. 3 is a schematic plan view illustrating an example of the vicinity of an electrode terminal in the present embodiment. FIG. 4 is a schematic plan view illustrating another example of the vicinity of the electrode terminal in the present embodiment. In FIGS. 3 and 4, the vicinity of the cathode terminal 82a is shown. Although not shown, the vicinity of the anode terminal 83a may have a configuration similar to that of the cathode terminal 82a.

An energy storage cell 1 includes a case 80, an electrode terminal, and a power generation element 50. The case 80 houses the power generation element 50. The electrode terminal includes a cathode terminal 82a and an anode terminal 83a.

The case 80 may be made of, for example, metal. The case 80 may include, for example, Al. The case 80 may have an outer shape in the form of a flat plate. The case 80 may have, for example, an elongated plate shape. The case 80 includes a case body 81 and a lid.

The outer shape of the case body 81 may be, for example, a rectangular parallelepiped shape. The outer shape of the case body 81 may be, for example, an elongated plate shape. The width of the case body 81 indicates the external dimension in the X direction. The case body 81 may have a width of, for example, 500 mm or more, 750 mm or more, or 1000 mm or more. The case body 81 may be, for example, 2000 mm or less, 1500 mm or less, or 1250 mm or less. The height of the case body 81 indicates the outer dimension in the Z direction. The height of the case body 81 may be, for example, 50 mm or more, 75 mm or more, or 100 mm or more. The height of the case body 81 may be, for example, 200 mm or less, 150 mm or less, 125 mm or less, or 100 mm or less. The thickness of the case body 81 indicates the external dimensions in the Y direction. The thickness of the case body 81 may be, for example, 5 mm or more, 10 mm or more, 15 mm or more, or 20 mm or more. The thickness of the case body 81 may be 30 mm or less, 25 mm or less, 20 mm or less, 15 mm or less, or 10 mm or less. The ratio of width to height may be, for example, 5 to 20. The ratio of width to thickness may be, for example, 50 to 200.

The case body 81 has an opening. The case body 81 may have, for example, a first opening 81a and a second opening 81b. That is, the case body 81 may have a cylindrical shape. The case body 81 may have, for example, a rectangular tubular shape. The first opening 81a may be located at one end in the axial direction (X direction). The second opening 81b may be located at the other axial end.

The lid closes the opening. The number of lids may be one or more than one. The number of lids corresponds to the number of openings of the case body 81. The case 80 may include, for example, a first lid 82 and a second lid 83. For example, the first lid 82 may close the first opening 81a. For example, the second lid 83 may close the second opening 81b. The lid is provided with an electrode terminal. For example, the first lid 82 may be provided with a cathode terminal 82a. For example, the second lid 83 may be provided with an anode terminal 83a. One lid may have one electrode terminal. One lid may have a plurality of electrode terminals. When one lid has a plurality of electrode terminals, the plurality of electrode terminals may have the same polarity or may have different polarities. For example, a liquid injection port 84 may be provided on the lid. For example, the liquid injection port 84 may be provided in the first lid 82.

For example, the thickness (d1) of the first lid 82 may be smaller than the shortest diameter (D1) of the first opening 81a. The thickness (d1) of the first lid 82 includes the thickness of the cathode terminal 82a. The “shortest diameter” indicates the shortest inner diameter among the inner diameters of the openings. For example, a relation such as “d1≤0.9×D1”, “d1≤0.8×D1”, “d1≤0.7×D1”, “d1≤0.6× D1”, or “d1≤0.5× D1” may be satisfied. For example, a relation such as “0.1D1≤d1”, “0.2D1≤d1”, “0.3D1≤d1”, “0.4D1≤d1”, or “0.5D1≤d1” may be satisfied.

For example, the thickness (d2) of the second lid 83 may be smaller than the shortest diameter (D2) of the second opening 81b. The thickness (d2) of the second lid 83 includes the thickness of the anode terminal 83a. For example, the relation of “D1=D2” may be satisfied. For example, the relation of “d1=d2” may be satisfied.

The lid is joined to the case body 81. For example, as shown in FIG. 2, the attitude of the first lid 82 is adjusted such that the first lid 82 fits in the first opening 81a. For example, the first lid 82 may be joined to the case body 81 by irradiating the fitting portion between the first lid 82 and the case body 81 with laser.

The power generation element 50 is also referred to as an “electrode assembly”. The power generation element 50 may include, for example, a cathode, an anode, a separator, and an electrolyte. The power generation element 50 may be of, for example, a laminated type or a wound type. The cathode and the anode may have a sheet shape. The cathode may contain, for example, lithium iron phosphate, a lithium nickel composite oxide, and the like. The anode may contain, for example, graphite, silicon oxide, silicon, or the like.

The cathode terminal 82a passes through the first lid 82. The cathode terminal 82a protrudes from the first lid 82 to the outside of the case 80 along the axial direction (X direction).

The anode terminal 83a extends through the second lid 83. In FIG. 2, the anode terminal 83a protrudes away from the cathode terminal 82a. In an embodiment, the anode terminal 83a may protrude in the same direction as the cathode terminal 82a. That is, both the cathode terminal 82a and the anode terminal 83a may be disposed on the second lid 83.

The electrode terminal may be made of an electrically conductive material. Examples of the electrically conductive material include a metal material, a carbon material, an electrically conductive resin material, and an electrically conductive ceramic material. In some embodiments, the electrically conductive material is an electrically conductive ceramic material. Since the electrically conductive ceramic material has a lower strength than other materials, the electrically conductive ceramic material is likely to be broken when an impact is applied. Therefore, for example, when the energy storage cells 1 are connected to each other, the electrically conductive path between the energy storage cell in which the abnormality has occurred and the normal cell can be interrupted.

The electrically conductive ceramic material may be a ceramic material with electrically conductive properties. The electrically conductive ceramic material may be a mixture of a ceramic material and an electrically conductive material (such as a carbon material). Examples of the electrically conductive ceramic material include silicon carbide, titanium oxide, titanium nitride, and titanium carbide.

The electrode terminal may be an integrally molded article or a composite body in which a plurality of separately molded electrode terminal members is joined.

The power generation element 50 has a current collecting tab. The current collector tab may include a cathode current collector tab 51 and an anode current collector tab 52. Each of the cathode current collector tab 51 and the anode current collector tab 52 may be a collection of a plurality of tabs (e.g., a tab bundle).

The cathode current collector tab 51 outputs the potential of the cathode. The cathode current collector tab 51 is electrically connected to the cathode included in the power generation element 50, and is electrically connected to the cathode terminal 82a. That is, the cathode terminal 82a is electrically connected to the cathode of the power generation element 50 via the cathode current collector tab 51. The cathode current collector tab 51 and the cathode terminal 82a may be joined (e.g., welded).

The anode current collector tab 52 outputs the potential of the anode. The anode current collector tab 52 is electrically connected to the anode included in the power generation element 50 and is electrically connected to the anode terminal 83a. That is, the anode terminal 83a is electrically connected to the anode of the power generation element 50 via the anode current collector tab 52. The anode current collector tab 52 and the anode terminal 83a may be joined (e.g., welded).

Note that the electrodes and the current collecting tabs may be integrally formed or may be separately formed and joined.

The energy storage cell 1 includes a gasket 90. The energy storage cell 1 may include one gasket 90, or may include a plurality of gaskets 90 (two gaskets 90a, 90b in FIGS. 3 and 4). The gasket 90 has electrically insulating properties. The gasket 90 may be made of, for example, resin or ceramic. The cathode terminal 82a may be inserted through the gasket 90.

The energy storage cell 1 may further include a sealing material 91. The sealing material 91 seals between the cathode terminal 82a and the case 80 (first lid 82). The scaling material 91 may be annular. The sealing material 91 may be electrically insulating. The sealing material 91 may be made of rubber, resin, or the like, for example. The scaling material 91 may have resistance to an electrolytic solution, for example.

The energy storage cells 1 may be used in a connected state. That is, the energy storage cells 1 can be used as an energy storage module or an energy storage device. A busbar 92 connects the electrode terminals between the energy storage cells 1. For example, the busbar 92 may connect the cathode terminal 82a and the anode terminal 83a. For example, the busbar 92 may connect the cathode terminal 82a and the cathode terminal 82a. For example, the busbar 92 may connect the anode terminal 83a and the anode terminal 83a.

The busbar 92 has electrically conductive properties. The busbar 92 may be made of, for example, metal. The busbar 92 may include, for example, aluminum (Al) or copper (Cu). The busbar 92 may be bonded to the electrode terminal. For example, the busbar 92 may be bonded to the electrode terminal by resistance welding, ultrasonic bonding, laser welding, or the like.

The electrode terminal has a member contact portion that is in contact with a different member. In the electrode terminal, either or both of the cathode terminal 82a and the anode terminal 83a have a recess 93 in the member contacting portion. Since the electrode terminal has the recess 93 in the member contact portion, the contact area between the electrode terminal and the different member is reduced. Therefore, when an external force such as an impact is applied to the electrode terminal, the electrode terminal and the different member are more easily disengaged from each other. As a result, the electrode terminal and the different member are separated from each other, and the electrically conductive path can be interrupted.

Examples of the different member include the current collector tabs, the gasket 90, and the busbar 92. The cathode terminal 82a may have the recess 93 in the member contact portion with at least one different member. Referring to FIGS. 3 and 4, the cathode terminal 82a may have either at least one recess 93 (recesses 93a, 93b, 93c in FIG. 3) or a plurality of recesses 93 (plurality of recesses 93a, 93b, 93c in FIG. 4) in the contact portions with the cathode current collector tab 51, the gasket 90a, and the busbar 92.

Either or both of the cathode terminal 82a and the anode terminal 83a need only have the recess 93 in the member contact portion with the different member. Both the cathode terminal 82a and the anode terminal 83a may have the recess 93 in the member contact portion with the different member. When both the cathode terminal 82a and the anode terminal 83a have the recess 93 in the member contact portion with the different member, the cathode terminal 82a and the anode terminal 83a may have the recess 93 in the member contact portion with at least one different member. Both the cathode terminal 82a and the anode terminal 83a may have either at least one recess 93 or a plurality of recesses 93 in the contact portions with the current collector tab, the gasket, and the bass bar.

In some embodiments, either or both of the cathode terminal 82a and the anode terminal 83a have a recess 93 at the contact portion with the busbar. As a result, conduction between the busbar and the electrode terminal is easily cut off, and when an impact is applied to the electrode terminal, an overcurrent can be suppressed from being transmitted from the energy storage cell in which the abnormality has occurred to the normal cell. In some embodiments, it is more desirable that both the cathode terminal 82a and the anode terminal 83a have the recess 93 at the contacting portion with the busbar.

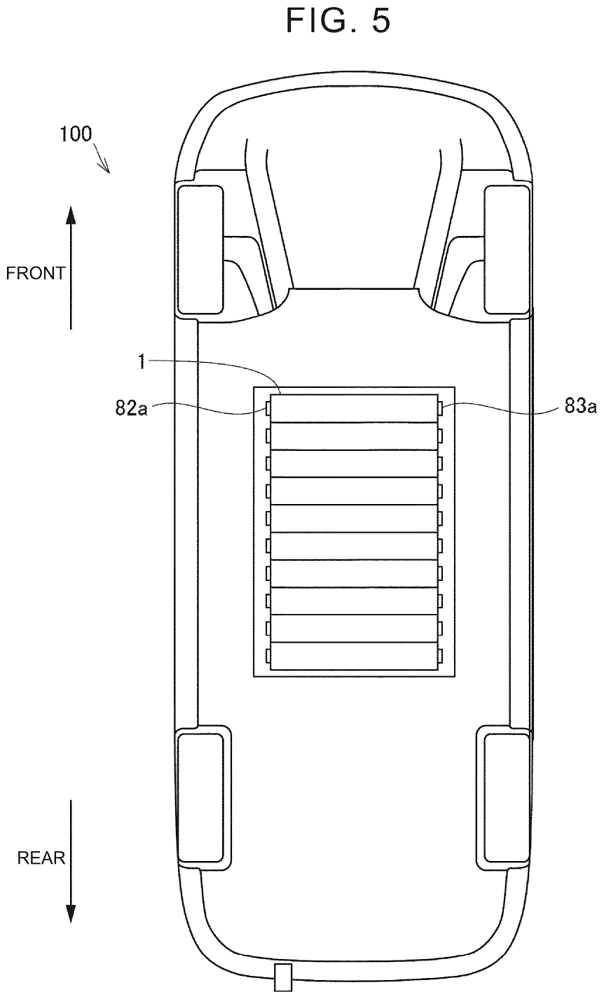

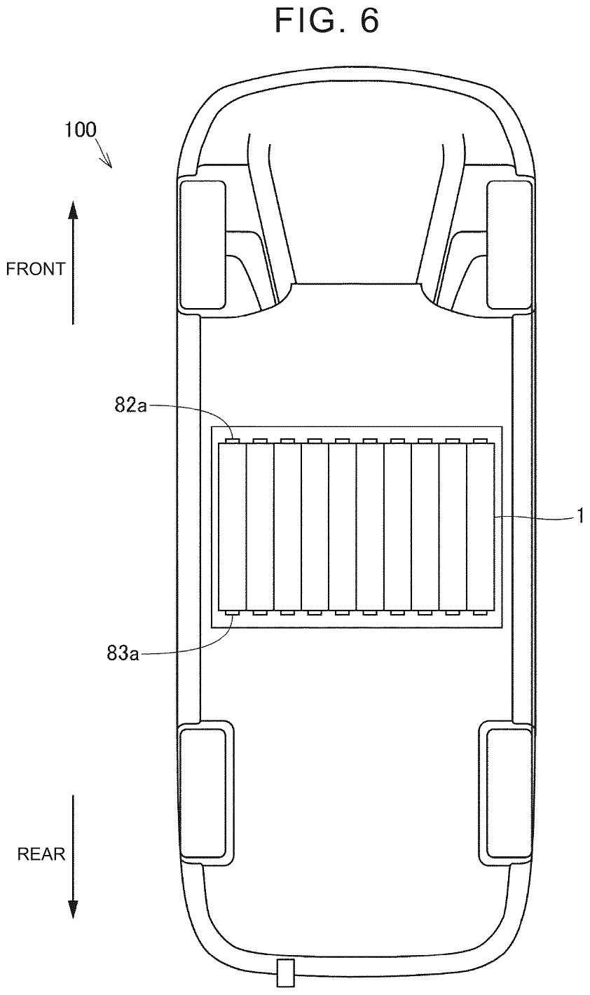

FIG. 5 is a schematic plan view illustrating an example of a case where the energy storage cells according to the present embodiment are mounted on a vehicle. FIG. 6 is a schematic plan view showing another example in the case where the energy storage cells according to the present embodiment are mounted on a vehicle. A vehicle 100 may be, for example, BEV (Battery Electric Vehicle), HEV (Hybrid Electric Vehicle), or PHEV (Plug-in Hybrid Electric Vehicle).

The vehicle 100 is equipped with the energy storage cells 1. In this case, the electrode terminals are configured to face outside the vehicle 100. When an impact is applied to the vehicle 100, an electrode terminals having a recess is disposed on the outer side of the vehicle 100 to which a large force is applied, whereby safety against a collision can be enhanced.

The energy storage cells 1 may be mounted on the vehicle 100 as an energy storage module. The energy storage cells 1 may be mounted on the vehicle 100 as an energy storage device. The energy storage cells 1 can be mounted at any desired positions. For example, the energy storage cells 1 may be disposed below the floor of the vehicle 100.

What is claimed is:

1. An energy storage cell including a case, an electrode terminal, and a power generation element, wherein:
the case houses the power generation element;
the electrode terminal includes a cathode terminal and an anode terminal;
the electrode terminal includes a member contact portion that is in contact with a different member; and
either or both of the cathode terminal and the anode terminal include a recess in the member contact portion.

2. The energy storage cell according to claim 1, wherein the cathode terminal and the anode terminal have the recess in the member contact portion.

3. The energy storage cell according to claim 1, wherein the different member is a busbar.

4. The energy storage cell according to claim 1, wherein the electrode terminal is made of an electrically conductive ceramic material.

5. The energy storage cell according to claim 1, wherein the electrode terminal is configured to face outside a vehicle when the energy storage cell is mounted on the vehicle.
